(19) United States
(12) Patent Application Publication
(10) Pub. No.: US 2026/0050717 A1
(43) Pub. Date: Feb. 19, 2026

(54) HYBRID UTILIZATION OF SUBGRAPH ISOMORPHISM AND RELATIONAL GRAPH CONVOLUTIONAL NETWORKS FOR ANALOG FUNCTIONAL GROUPING ANNOTATION

(71) Applicant: Drexel University, Philadelphia, PA (US)

(72) Inventors: Ioannis Savidis, Wallingford, PA (US); Zhengfeng Wu, Philadelphia, PA (US); Isabel Song, Philadelphia, PA (US)

(73) Assignee: Drexel University, Philadelphia, PA (US)

(21) Appl. No.: 19/299,883

(22) Filed: Aug. 14, 2025

Related U.S. Application Data
(60) Provisional application No. 63/683,104, filed on Aug. 14, 2024.

(51) Int. Cl. G06F 30/27; G06F 30/323

(52) U.S. Cl. CPC G06F 30/27; G06F 30/323

(57) ABSTRACT

Methods, systems, and computer-readable media are used in graph-based machine learning of analog integrated circuits (ICs). In a first aspect, functional device pairs in transistor-level circuits are detected and classified using a hybrid approach combining a subgraph isomorphism algorithm, such as VF2, with a trained relational-graph convolutional network (RGCN). The VF2 algorithm identifies candidate pairs and initial categories, while the RGCN filters false positives using link prediction scores, preserving category labels for validated pairs. In a second aspect, a relational GraphSAGE model performs multi-class link prediction on a heterogeneous graph with netlist and functional relation edge types, labeling device pairs into analog primitive categories without technology-dependent features and merging overlapping pairs into larger functional groups. In a third aspect, circuit performance is predicted using a hierarchy-aware graph neural network comprising an edge-conditioned convolution (ECC) layer and multiple Circuit graph isomorphism network layers corresponding to hierarchy levels of device groupings.

This disclosure includes 3 subsections grouped under I, II, and III within each section. Each section includes figures, tables, and equations that are preceded by a corresponding section number. For example, the Figures related to Section I all begin with 1.

### I. Background for Hybrid Utilization of Subgraph Isomorphism and Relational Graph Convolutional Networks for Analog Functional Grouping Annotation

Automated synthesis of analog circuits has been an area of active research. Analog synthesis typically begins with the design or selection of a circuit topology for a target application. Next, the device sizes of an analog circuit are optimized at the schematic level. The layout is then generated based on the completed schematic. A hierarchical approach is typically adopted for analog synthesis, considering both device and system-level requirements and constraints. At the device level, circuit blocks that implement different functions may include analog primitives, including differential pairs and current mirrors, which, when put together, form more complex system-level designs.

During the layout phase, skilled designers adeptly determine the functionality of each device and the grouping of devices, which are then used as constraints to ensure symmetry and matching in the layout. For instance, the implementation of differential signaling is a common practice in analog design to enhance common-mode noise rejection. Matching the placement and routing of differential pairs, therefore, becomes essential to minimize the effects of interconnect impedance, the environment, and process variations. Empirical layout techniques have been developed including the common centroid layout style that requires that centroids of each device align precisely and that devices exhibit symmetry around both the X and Y axes in a 2-D layout. Recent efforts to automate layout synthesis often leverage a schematic-level netlist as the initial reference point. Annotating the netlist, therefore, becomes a vital step that provides the necessary constraints to optimize the layout of an analog circuit.

To address system-level design considerations, a method has been proposed that employs a spectral graph convolutional network (GCN) to classify components of a design into multiple hierarchical levels, assuming an initial flattened netlist. However, in practice, system-level designs are typically described in a hierarchical netlist format, where circuit functionalities are already specified. A system-level symmetry annotation method may use graph centrality measures to extract subcircuits that are then evaluated through graph similarity analysis.

At the device level, circuit netlists typically lack annotations on the functional building blocks that embody abstract analog design principles. Achieving automated and accurate recognition of analog primitives at the device level and at a low computational cost is crucial for advancing the automation of analog design. A graph-based device and interconnect matching scheme may leverage the sensitivity of device parameters on the performance of a circuit. To recognize circuit symmetry, symmetrical connection trees (SCTs) offer quadratic time complexity. A structural signal flow representation may be used to compute symmetry and generate hierarchical placement rules for analog circuits. The identification of analog functional blocks at the device level has been formulated as a subgraph isomorphism problem. A predefined library of analog functional blocks is developed, and a graph representation of the circuit is generated. Subsequently, subgraphs of the circuit graph are compared against each graph in the library. The subgraph isomorphism test is NP-complete and returns the type of an identified functional pair. The execution time scales with the size of the subgraphs to match, which is not prohibitively expensive at the device level as analog circuits are typically comprised of a limited number of transistors. However, the isomorphism-based matching algorithm results in false positives among the detected pairs.

In recent years, learning-based techniques have emerged to annotate analog circuits primarily for symmetry detection. As circuits are represented as graphs, graph neural networks (GNNs) have been used to identify analog primitives. For the detection of hierarchies and symmetry, GNNs are trained to predict graph edit distance (GED) scores between subgraphs of a circuit. However, evaluating the exact GED scores of subgraphs used in the training set remains computationally costly. GNNs may be used to classify if two nodes in a circuit constitute a symmetric pair. A rule-based filter and a probability-based filter are then applied for postprocessing to remove false positives from the results. An unsupervised inductive learning framework may be implemented by training GNNs on a heterogeneous graph representation of analog circuits to predict symmetry at both the device and system level. Results of the study indicate that device-level symmetry detection yields a lower F1 score on average than that of system-level detection, suggesting that detecting symmetry at the device level is more challenging than at the system level. Methodologies that use binary prediction do not provide information on the category of a detected pair, such as whether the pair corresponds to a current mirror or a differential pair, which indicates a potential area of future research.

### II. Background for Comparative Analysis of Graph Isomorphism and Graph Neural Networks for Analog Hierarchy Labeling

Automated synthesis of analog circuits has been an area of active research, with various frameworks and methodologies proposed. A hierarchical design approach is usually applied. At the device level, circuit blocks are composed of fundamental analog primitives including differential pairs and current mirrors. The primitives then collectively form more intricate system-level designs. In practical scenarios, hierarchical information is often provided in circuit netlists at the system level, while annotation of functional building blocks is lacking at the device level. Recognizing circuit hierarchies is critical for subsequent circuit design tasks, including for the automated synthesis of analog ICs. The capability of a model to distinguish between circuit structures, given a set of specifications, allows for the automated synthesis of a topology. The analog device groupings also provide matching constraints for layout optimization.

Heuristic methods have been developed to automate the annotation of device groupings, where the graph of a circuit is compared with a library of primitive circuit graphs for isomorphism matching. An automatic structure recognition method has been proposed that dynamically constructs the library of primitives during the detection process. More recently, graph neural networks (GNNs) that learn on circuit topological graphs have been applied for symmetry detection. Spectral graph convolutional networks (GCNs) are used to classify components of a design into hierarchical levels by assuming a flattened system-level netlist. GNNs are trained to predict graph edit distance (GED) scores, which are used as a measure of similarity between subgraphs of a circuit. However, computing exact GED scores for subgraphs as ground truth for similarity remains computationally expensive. An unsupervised clustering technique is proposed to automate the detection of circuit substructures. GNNs are implemented on a heterogeneous graph representation of an analog circuit to predict symmetry at both the device and system level.

With library-based isomorphism detection, labels of the functional type of each grouping are returned. However, prior learning-based models were developed only for binary prediction or clustering of symmetrical device groups, where the specific category of a detected pair was not returned. Determining the type of functional pairing offers multiple benefits. Firstly, differentiating between functional pair classes provides more information for the model to learn from, which results in improved model performance. Secondly, functional pair types are potentially used as features in learning models for downstream applications. Thirdly, a model that automatically learns to identify circuit topological structures, beyond the detection of device groupings, is an initial step towards the application of machine reasoning in circuit design. A hybrid method that uses both a subgraph isomorphism algorithm and a GNN model may return the specific category of each detected functional pair. However, the hybrid method requires the implementation of both a library of primitives and a circuit dataset for learning.

Another limitation of prior work is the inclusion of device sizes as features. As devices in the same functional group are usually sized the same for matching, the device sizes already indicate the grouping of transistors. As a result, the models are not generalized across technology nodes and are not applicable before sizing.

### III. Background for Circuit-GNN: A Graph Neural Network for Transistor-Level Modeling of Analog Circuit Hierarchies

Performance modeling of circuits is a critical part of design. Analytical models are typically used to guide manual optimization, where the relationship between design variables and target performance parameters is analyzed. Specifically, for analog ICs, devices are sized to ensure that the circuit meets the design specifications. More recently, machine learning models have been trained on circuit data as a substitute for analytical solutions to model and optimize an analog circuit. The automatically extracted design parameters significantly reduce the required human effort. However, generating data from numerical solvers is computationally expensive, while expert design data is mostly proprietary. The limited availability of circuit data motivates the reuse of prior characterized data and the generalization of learning models. A majority of the circuit models are not adaptive to changes in circuit topologies, which prohibits the simultaneous learning from the data of different topologies as each topology represents a unique mapping from the design space to the performance space. A new dataset is, therefore, often required for each new circuit to model. If learning models are generalized, reusing the modeling and design information of prior circuits is feasible through the pre-training and fine-tuning of the models graph neural networks (GNNs) provide the capability of simultaneous learning from the dataset of different topologies, which traditional learning algorithms including decision trees and artificial neural networks (ANNs) do not allow.

Recently, GNNs have emerged as a substitute of traditional neural networks for the modeling of integrated circuits. Circuit topology, including device connectivity information, is provided for the training of the GNNs, where principles of convolutional neural networks are applied to the non-Euclidean graph-structured data. The intuition behind GNNs is to aggregate feature embeddings based on the graph topology. Similar nodes, typically topologically close in a graph, are assigned similar embeddings. In the digital domain, a GCN-based model is proposed to estimate gate arrival time at the logic level [6]. For analog ICs, GNNs have been applied to the design of distributed circuits, analog circuit sizing, estimation of layout parasitics, and performance prediction based on placement. Satisfactory model performance has been shown for GNNs used for these circuit applications.

Beyond satisfying performance specifications, additional design constraints such as symmetry and the matching of devices are required to ensure the robustness of analog circuits. While techniques based on GNNs have been proposed to automatically extract the symmetry constraints and annotate circuit netlists, the primary objectives of these works are for annotating circuit netlists and guiding layout generation. The grouping information of the devices for symmetry, matching, and circuit hierarchies has not been fully used in the training of the GNNs.

### SUMMARY OF THE EMBODIMENTS

The present invention relates to graph-based machine learning techniques for analog integrated circuit (IC) analysis and design automation, and in particular to methods, systems, and computer-readable media for:
1. Detecting and classifying functional device pairs in transistor-level analog circuits using a hybrid subgraph isomorphism and graph neural network (GNN) approach;
2. Labeling functional device hierarchies in analog circuits via a relational GraphSAGE (R-SAGE) model configured for multi-class link prediction; and
3. Predicting circuit-level performance using a hierarchy-aware GNN architecture (Circuit-GNN) that combines edge-conditioned convolution (ECC) with multi-level aggregation (Circuit-GIN layers).

### I. Summary for Background for Hybrid Utilization of Subgraph Isomorphism and Relational Graph Convolutional Networks for Analog Functional Grouping Annotation

Recently, graph neural networks (GNNs) have been applied to various circuit applications, where circuit topology is leveraged in the learning of the models. However, the aggregation of GNN models has not accounted into account circuit hierarchies. In addition, the generalization of GNNs to distinguish between different circuit topologies is not currently provided, which raises the question of whether one GNN is sufficient to simultaneously model differing circuit graphs. In this work, a graph representation is proposed, based on a given circuit netlist, to model analog circuits at the transistor level. Additional categorical features are included to address the ambiguity in modeling the connections of the terminals of a given transistor. Edge-conditioned convolution (ECC) is employed, where weight matrices are trained based on the edge attributes within the local neighborhood of a given node. A relational graph is constructed to model groupings of devices for each level of the hierarchy provided by the designer. Each adjacency matrix of the relational graph is processed by a graph isomorphism network (GIN) layer, described as a Circuit-GIN layer, to update the node embeddings. The model includes an ECC layer and two Circuit-GIN layers, described as a Circuit-GNN, is trained on data from four op-amp topologies to predict four performance parameters. Results indicate that the ECCbased model outperforms a GCN-based model in the prediction of all of the performance parameters, which results from the additional edge information learned by the ECC layer. With the addition of Circuit-GIN layers, the Circuit-GNN outperforms the ECC-only model by up to 16.7% in R2 score. Therefore, aggregation of node embeddings based on device groupings brings additional benefit to guide the GNNs in modeling the performance of analog ICs. The model also validates the expressive power of the proposed GNN model, which generates embeddings that distinguish between different circuit graphs. The generalization of GNNs renders feasible the simultaneous learning from different analog topologies.

Said differently, the hybrid method combines heuristic isomorphism matching and a GNN-based link prediction model, leveraging the advantages of both approaches. Specifically, the subgraph isomorphism test, executed on an analog circuit, provides an initial recognition of functional pairs and the categorical type of each pair. Concurrently, a relational graph convolutional network (RGCN) model is used to predict whether two transistor nodes are a functional pair based on the connectivity described by the circuit netlist, which resembles a friend recommendation system for a social network. By combining the results from the two approaches, the analog functional pairs are detected at the device level with improved accuracy, while the categorical type of the functional pair is also returned. In addition to generating symmetry constraints for layout automation, the determined functional pair types offer utility as features in machine learning models for other circuit applications at both the schematic and layout level. As an example, by leveraging the hierarchical groupings of devices, improved generalization is achieved by applying graph neural networks to simultaneously model the performance of multiple analog circuits.

### II. Summary for Comparative Analysis of Graph Isomorphism and Graph Neural Networks for Analog Hierarchy Labeling

Automated synthesis of analog ICs requires recognition of circuit hierarchies at both the device level and system level. The capability of a model to distinguish between circuit structures allows for the automated synthesis of a topology given a set of specifications. The device groupings also provide symmetry and matching constraints for layout optimization. Traditional methods based on graph isomorphism matching require a manual setup of a library of primitives. While learning-based approaches have been proposed that do not require a library, the categorical specification of a detected group is not returned by prior algorithms. In addition, device sizes are used as features, which render the models technology-dependent and infeasible for use before device sizing is performed. To address such limitations, a relational GraphSAGE (R-SAGE) model is proposed that performs multi-class link prediction instead of binary prediction for the labeling of analog functional pairs. The R-SAGE model is characterized and compared with the subgraph isomorphism algorithm VF2 on a dataset that includes 14 analog circuits with a total of 219 transistors and 120 functional pairs that span seven primitive categories. The RSAGE model achieves an average macro F1-score of 0.864 and exhibits an average testing time of 80.3 ms across 10 executed runs, outperforming VF2 that provides an average F1-score of 0.841 and an average test time of 594 ms. The proposed R-SAGE model advances machine learning based reasoning of circuit topology. The learned hierarchies provide utility for downstream tasks in the modeling and design of analog circuits.

To address the limitations of prior approaches, a GNN model labels analog functional groups at the device level.

A relational GraphSAGE model is implemented that uses a heterogeneous graph representation of an analog circuit to detect and label primitive device groupings. The model learns solely from circuit topological features without requiring technology-dependent parameters.

The proposed learning-based approach is benchmarked and compared with the traditional isomorphism matching algorithm VF2. Results indicate that the GNN model provides improved accuracy and execution time as compared to VF2, while eliminating the need to construct a library of primitives.

### III. Background for Circuit-GNN: A Graph Neural Network for Transistor-Level Modeling of Analog Circuit Hierarchies

Recently, graph neural networks (GNNs) have been applied to various circuit applications, where circuit topology is leveraged in the learning of the models. However, the aggregation of GNN models has not accounted into account circuit hierarchies. In addition, the generalization of GNNs to distinguish between different circuit topologies is not currently provided, which raises the question of whether one GNN is sufficient to simultaneously model differing circuit graphs. In this disclosure, a graph representation is proposed, based on a given circuit netlist, to model analog circuits at the transistor level. Additional categorical features are included to address the ambiguity in modeling the connections of the terminals of a given transistor. Edge-conditioned convolution (ECC) is used, where weight matrices conditioned on the edge attributes are trained in the local neighborhood of a given node. A relational graph is constructed to model groupings of devices for each level of the hierarchy provided by the designer. Each adjacency matrix of the relational graph is processed by a graph isomorphism network (GIN) layer, described as a Circuit-GIN layer, to update the node embeddings. The model includes an ECC layer and two Circuit-GIN layers, described as a CircuitGNN, is trained on data from four op-amp topologies to predict four performance parameters. Results indicate that the ECCbased model outperforms a GCN-based model in the prediction of all of the performance parameters, which results from the additional edge information learned by the ECC layer. With the addition of Circuit-GIN layers, the Circuit-GNN outperforms the

ECC-only model by up to 16.7% in R2 score. Therefore, aggregation of node embeddings based on device groupings brings additional benefit to guide the GNNs in modeling the performance of analog ICs. The work also validates the expressive power of the proposed GNN model, which generates embeddings that distinguish between different circuit graphs. The generalization of GNNs renders feasible the simultaneous learning from different analog topologies.

A graph representation models analog circuits at the transistor level and accounts for the transistor terminals. The grouping information of the devices based on circuit hierarchies is encoded into a relational graph. With the proposed Circuit-GIN layers, node embeddings are aggregated based on not only the circuit topology but also the relational graphs. This is the first work that customizes the GNN aggregation based on circuit hierarchy.

### BRIEF DESCRIPTION OF THE DRAWINGS

FIGS. 1.1a-1.1g show predefined library including seven common analog primitives: FIG. 1.1a) current mirror, FIG. 1.1b) level shifter, FIG. 1.1c) cross-coupled pair with a shared source, FIG. 1.1d) cross-coupled pair without a shared source, FIG. 1.1e) gate pair with a shared source, FIG. 1.1f) gate pair without a shared source, and FIG. 1.1g) differential pair.

FIG. 1.1.1 shows Table 1.1.

FIG. 1.2a-1.2c show an amplifier in FIG. 1.2a) schematic form, FIG. 1.2b) graph representation for application of VF2, and FIG. 1.2c) graph representation for application of the RGCN model.

FIG. 1.2.1 shows an algorithm and Equations 1.1-1.3.

FIG. 1.2.1 shows Equations 1.4-1.7.

FIG. 1.3 shows an execution flow of the hybrid approach that combines the VF2 algorithm with an RGCN model.

FIG. 1.4 shows a confusion matrix of the functional pairs detected by the VF2 algorithm.

FIG. 1.5 shows F1 score as a function of threshold based on results of testing on a single circuit Three scenarios are shown when applying the RGCN model to predict edge type: 1) on the training set, 2) on all possible transistor pairs from the test circuit, and 3) on functional pairs detected by VF2 from the test circuit.

FIGS. 2.1a-2.1g show predefined library including seven common analog primitives: FIG. 2.1a) current mirror, FIG. 2.1b) level shifter, FIG. 2.1c) cross-coupled pair with a shared source, FIG. 2.1d) cross-coupled pair without a shared source, FIG. 2.1e) gate pair with a shared source, FIG. 2.1f) gate pair without a shared source, and FIG. 2.1g) differential pair.

FIG. 2.1.1 shows Table 2.1.

FIG. 2.1.2 shows Table 2.2.

FIG. 2.2 shows a graph representation of an amplifier used with the execution of the VF2 heuristic algorithm and the R-SAGE model. The aggregation of the embeddings of node M2 with R-SAGE and the final model architecture are also shown.

FIG. 2.2.1 shows an algorithm and Equations 2.1-2.3.

FIG. 2.2.2 shows Equations 2.4-2.8.

FIGS. 2.3a and 2.3b show a confusion matrix of the predictions generated with FIG. 2.3a) VF2, and FIG. 2.3b) the R-SAGE model, when all possible pairs are queried.

FIG. 2.4 shows a confusion matrix indicating a perfect identification of functional pair types with the R-SAGE model when assuming that the existence of pairings is known.

FIGS. 2.5a and 2.5b show the (FIG. 2.5a) schematic representation of a telescopic OTA and (FIG. 2.5b) the 2-dimensional t-SNE components of the 32-dimensional embeddings of transistor nodes of the OTA generated with R-SAGE during testing.

FIG. 3.1 shows a proposed GNN model architecture includes an ECC layer and two Circuit-GIN layers that operate on topology and relational graphs.

FIG. 3.1.1 shows Table 3.1.

FIG. 3.1.2 shows Table 3.2.

FIG. 3.2.3 shows Table 3.3.

FIG. 3.2.4 shows Table 3.4.

FIGS. 3.2a-3.2d show circuit topologies of FIG. 3.2a) two-stage op-amp, FIG. 3.2b) three-stage op-amp, FIG. 3.2c) folded cascode op-amp, and FIG. 3.2d) telescopic cascode op-amp.

FIG. 3.2.1 shows Equations 3.1-3.4.

FIGS. 3.3a-3.3c show characterizations of the predicted versus actual values of the CMRR when using FIG. 3.3a) a model with a GCN layer, FIG. 3.3b) a model with an ECC layer, and FIG. 3.3c) a model with an ECC layer and two Circuit-GIN layers.

### DETAILED DESCRIPTION OF THE EMBODIMENTS

### I. Description for Hybrid Utilization of Subgraph Isomorphism and Relational Graph Convolutional Networks for Analog Functional Grouping Annotation

### Methodology and Problem Formulation

The objective of recognizing the primitives of an analog circuit at the device level is defined as: Identify the set S of all pairs of devices that belong to the functional pair type i such that Si={(di1, di2), (di3, di4), . . . }, where d represents a device in the circuit. In this section, the proposed device level analog subblock recognition flow is described. The heuristic subgraph isomorphism algorithm, VF2, is introduced in Section A, where the required graph representation and the library of analog primitives are provided. In Section B, the RGCN model with the required graph representation is analyzed for link prediction. In Section C, the hybrid flow that combines VF2 and RGCN is described.

### A. VF2: Subgraph Isomorphism for the Recognition of Analog Primitives

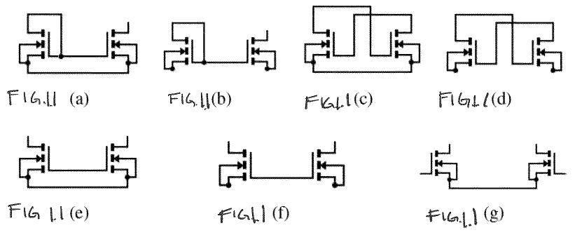

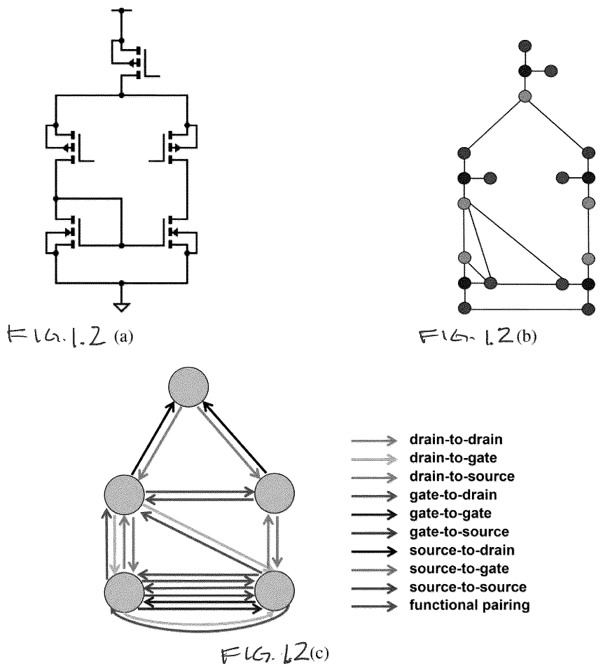

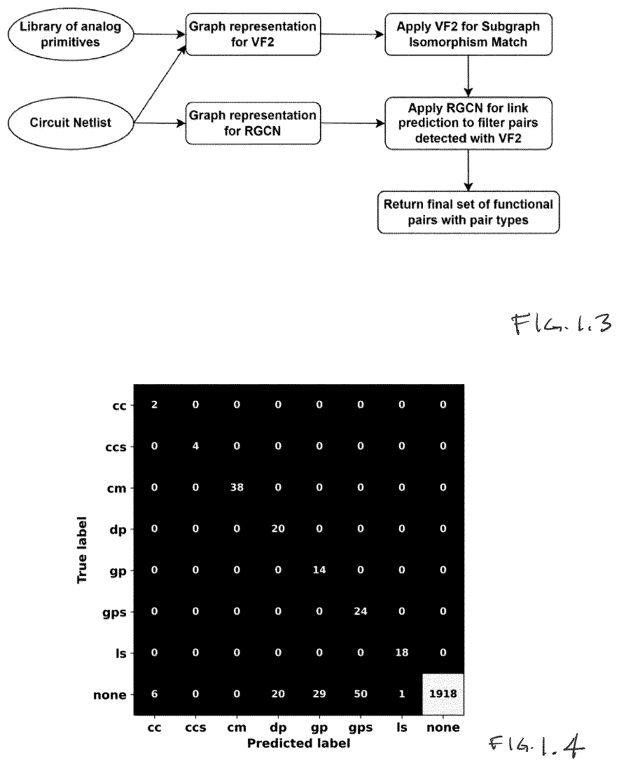

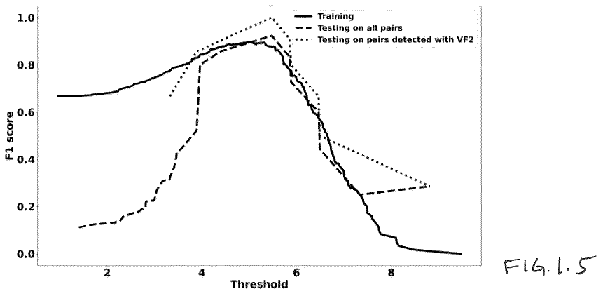

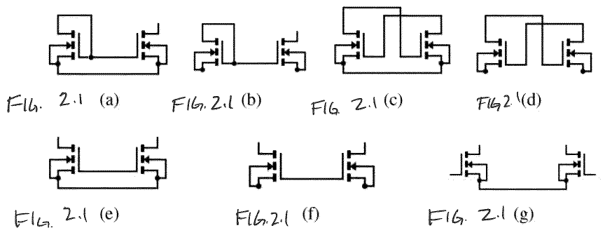

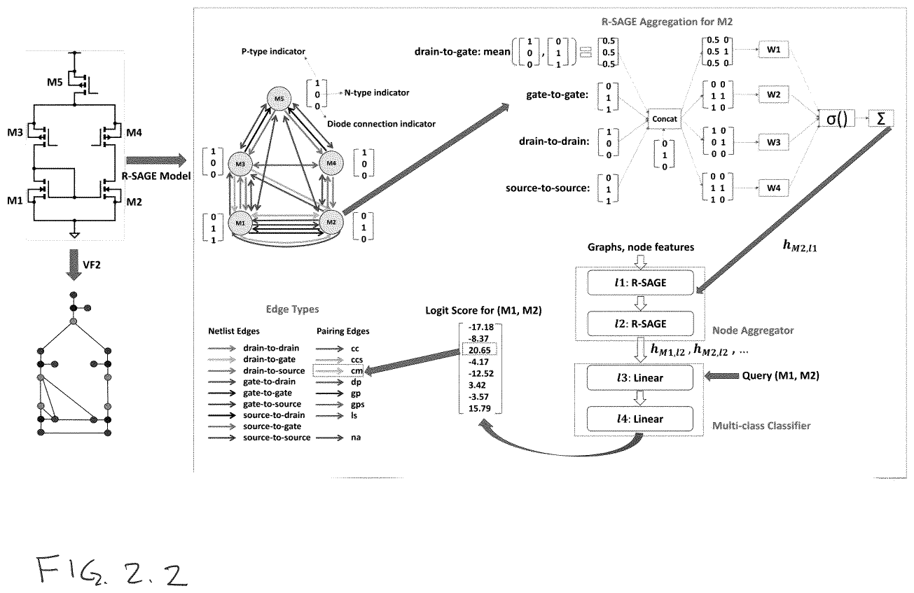

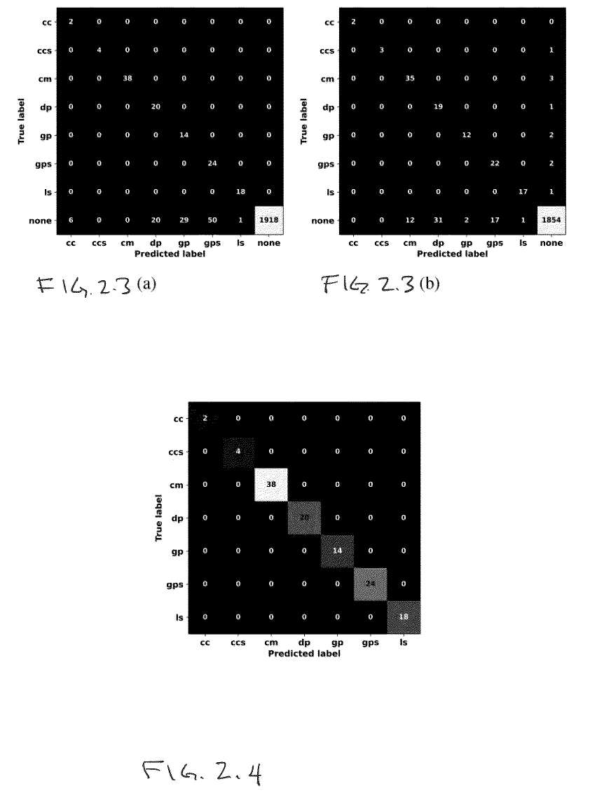

Given a graph G0 of the circuit under test, the objective of the subgraph isomorphism test is to determine if G0 contains a subgraph that is isomorphic to the graph Gi of the ith analog primitive in a predefined library. In this work, a primitive library is defined that includes seven distinct functional topological structures that include a current mirror (cm), a level shifter (ls), cross-coupled pairs with (ccs) and without (cc) a shared source net, gate pairs with (gps) and without (gp) a shared source net, and a differential pair (dp), as shown in FIG. 1.1a-1.1g. In the graph representation of a circuit used for subgraph isomorphism matching, a transistor is represented by three terminal nodes indicating the drain, gate, and source and an identity node central to the three terminal nodes indicating the transistor. The identity node is connected solely to the terminal nodes of the same transistor, while connections between the terminal nodes signify circuit nets. The graph representation of an amplifier (schematically shown in FIG. 1.2(a)) provided as input to the VF2 algorithm is shown in FIG. 1.2(b).

The exact subgraph isomorphism algorithm, VF2 uses a state space representation to search for an isomorphic match. Starting with an initial state s0, node pairs are generated as candidates and evaluated with a set of feasibility rules. If the feasibility check passes, the node pair is added to the next state s1. The procedure repeats recursively following a depth-first search strategy. The pseudocode of the VF2 routine is provided as Algorithm 1 in FIG. 1.2.1.

B. Link Prediction with RGCN for the Recognition of Analog Primitives

The detection of analog functional pairs at the device level is transformed into a link prediction problem. The objective is to develop a model to predict the presence or absence of an edge (link) that represents the functional pairing relation between a queried pair of nodes. To model device-level analog circuits, a heterogeneous directed graph representation is used, includes one node type representing transistors and ten edge types representing links between transistors, as shown in FIG. 1.2(c). Nine of the ten edge types, referred to as netlist edges, are used to represent all possible unidirectional connections between the terminals of a pair of transistors. The tenth edge type is used to represent the functional pairing between two transistors. The graph representation of an amplifier used with the RGCN model is shown in FIG. 1.2(c) with the ten edge types marked in different colors.

The list of transistor nodes includes a categorical feature that indicates the type of transistor (N-type or P-type). In addition, to account for connections between terminals of the same transistor, a categorical feature is used to indicate the presence of a diode connection between the gate and the drain of a given transistor. Similarly, features for drain-source connections (i.e., a transistor used as a capacitor) and gate source connections are also added. In some approaches, device sizes and the number of metal layers are used as features. However, in this work, technology-dependent parameters are excluded to ensure the generalization of the model to circuits from different technologies.

Relational graph convolutional network (RGCN) layers are included in the model, which operate on the heterogeneous graph. In each RGCN layer, graph convolution is iteratively performed on a specific node for each incident edge type. Subsequently, the embedding of the node is updated by summing the embeddings of all nine edge types. The updated embedding h^{l+1}_{dst} of the node is given by Equation 1.1 (FIG. 1.2.1), where o is the nonlinear activation function, W is the trainable weight matrix, R is the set of nine edge types described by the netlist, and N^{r}_{dst} is the set of neighboring nodes with incident edges of type r. Therefore, for a GNN model with k RGCN layers, features from a k-hop neighborhood are effectively aggregated on each transistor node, when considering all incident edge types specified in the netlist.

With the formulation of the link prediction problem, a similarity score is generated for a queried pair of transistor nodes that reflects the likelihood of the presence of a functional pairing edge. Therefore, the prediction scores must be sufficiently high for existing edges and low for non-existing edges. In this work, the score is computed as the dot product of the embeddings of the two queried nodes as given by Equation 1.2 (FIG. 1.2.1), where hu and hv are the embeddings of node u and node v, respectively.

For each circuit, a positive graph and a negative graph are generated, which contain an equal number of transistor nodes and the nine types of netlist edges. In the positive graph, edges for functional pairings are added between transistors that are in the same functional group, while the negative graph includes negative edges added between transistors that do not belong to the same functional pair. During the training phase, only a subset of negative edges is included in the negative graph of each circuit of the training set. If a circuit contains m true functional pairing edges, K·m negative edges are included, where K is the ratio of the number of positive edges to the number of negative edges. The sampling approach ensures that there is a balanced representation of positive and negative edges in the training data. Margin loss is adopted as the loss function to minimize during training, which is given by Equation 1.3 (FIG. 1.2.1).

In Equation 1.3, y(u,v) is the predicted score of the edge between two transistor nodes in a functional pair from the positive edge set Sp, and y(u,v) is the predicted score of a negative edge between two transistor nodes that are not in a functional pair from the negative edge set Sn.

To evaluate the performance of the classifiers, recall (true positive rate), precision (positive predictive value), F1 score, and accuracy are used, which are defined as shown in Equations 4-7 (FIG. 1.2.2), where TP, TN, FP, and FN represent the number of true positives, true negatives, false positives, and false negatives, respectively. The area under curve (AUC) scores for the precision-recall (PR) curve and the receiver operating characteristic (ROC) curve are also evaluated.

During the testing phase, the model evaluates a raw prediction score for the edge between every possible pair of transistors. To determine if an edge exists or not, a threshold is applied to the raw prediction scores. Any score above or equal to the threshold is considered a positive prediction that indicates the presence of an edge, while any score below the threshold is considered a negative prediction that indicates the absence of a functional edge. To determine the optimal threshold, the F1 score is used as the evaluation metric. The threshold that maximizes the F1 score on the training set is selected as the threshold for making predictions during testing.

### C. Hybrid Approach Using VF2 and RGCN for the Recognition and Labeling of Analog Primitives

The RGCN model, when executed alone, does not return the categorical type of a detected pair. A hybrid approach is proposed that combines the VF2 algorithm with the RGCN model such that the advantages of both methods are leveraged to achieve more accurate and informative results.

The execution flow of the hybrid method for detecting analog functional pairs at the device level is shown in FIG. 1.3. The VF2 algorithm is executed on the graph of an analog circuit to determine initial functional pairs. The detected pairs are then passed to the RGCN model, which predicts the presence of links between devices forming a functional pair based on the device connectivity provided in the circuit netlist.

### Simulation Results

A dataset is collected for the characterization of the proposed techniques, which includes 14 analog circuits with a total of 219 transistors. The SPICE netlists of the 14 circuits are used to construct corresponding graphs. The functional groupings of each circuit in the dataset are manually labeled, resulting in a total of 120 functional pairs belonging to the seven primitive categories described. The labeled dataset serves as the ground truth for evaluating the performance of the proposed approach in detecting and classifying analog functional pairs at the device level.

To train and evaluate the RGCN model, a cross-validation approach is used. During each execution, one circuit is selected for testing and the remaining 13 circuits are used for training. The value of K, which represents the ratio of the number of positive edges to the number of negative edges in the training set, is set to 1. The model architecture includes three RGCN layers, with 32 hidden units in the first two layers and 64 hidden units in the final layer.

Three methods for transistor pairing and labeling are analyzed: the VF2 algorithm, the RGCN model, and the proposed hybrid flow that combines the two individual methods. The average performance given by AUC, accuracy, precision, recall, and F1 score and the average execution time of the three approaches in identifying the functional pairs of analog circuits are listed in Table I.1 (FIG. 1.1.1). A confusion matrix that summarizes the predictions generated by VF2 is provided in FIG. 1.4.

### Analysis of Results

As indicated by the results listed in Table 1.1, the subgraph isomorphism algorithm VF2 achieves a perfect recall of 1. Therefore, all 120 functional pairs are correctly identified. The precision, however, is 0.641, indicating that, on average, 35.9% of the detected pairs are false positives. The bottom row of the confusion matrix shown in FIG. 1.4 indicates the total number of false positives for each functional pair type across the 14 circuits. The confusion matrix also highlights the unique advantage provided by VF2 that, if a detected pair is not a false positive, the categorical type of the pair returned by VF2 is always accurate.

Three primary factors contribute to the false positives of the detected pairs. The first and most impactful factor is attributed to transistors whose source or drain terminals are connected to high-degree net nodes such as power or ground. Consequently, such transistors are incorrectly recognized as differential pairs, which results in the detection of false positives. The second factor is commonly observed in mixed-signal circuits, where pairs of transistors share a clock signal or gate bias voltage, even when the transistors do not form a functional pair. The third factor occurs when NMOS-PMOS pairs are incorrectly classified as cross-coupled.

The results listed in Table 1.1 indicate that the independent execution of VF2 proves capable of detecting functional pairs at the device level. However, due to the high number of false positives, inspection by human designers is required to validate all detected pairs before being used in analog modeling and synthesis. In an automated flow, techniques that effectively eliminate false positives from the detected pairs are imperative. In a circuit includes n transistors, the number of possible edges between a pair of transistors, while considering directed graph representation, is n(n−1). When the circuit includes m functional pairing edges, the total number of possible negative edges is given by n(n−1)−m, which often exceeds m. During training, only K·m negative edges are included. To maintain balance in the training set, the value of K is set to 1. However, the results listed in Table 1.1 are obtained by applying the RGCN model on all positive and negative edges of the test circuit, which results in an imbalanced testing set. As indicated by the results listed in Table 1.1 for the predictive performance of the RGCN model alone, the accuracy of 0.917 and the precision of 0.595, although appearing contradictory, result from the imbalance of the testing set. When VF2 and the RGCN model are used together, the resulting precision is 0.840, as listed in Table 1.1. Therefore, the RGCN model provides improved performance when predicting among the functional pairs detected by the VF2 algorithm. The recall of the hybrid approach is limited (equal) to the recall provided by the RGCN model, as the VF2 algorithm already provides a perfect recall of 1. As a result, the hybrid approach achieves the highest F1 score of 0.882, an improvement of 0.111 or 14.4% over the F1 score provided by the VF2 algorithm when executed standalone, as indicated by the results listed in Table 1.1. The improvement provided by the hybrid approach resembles the benefits provided by ensemble learning, where a combination of diverse models results in enhanced performance as compared to the utilization of a single model or algorithm.

The selection of an appropriate threshold for converting raw prediction scores into binary predictions significantly influences the performance of the model. In other approaches, an empirically determined threshold of 0.99 is adopted for the unsupervised GNN model used for device-level symmetry detection. In the current approach, the optimal threshold is determined by maximizing the F1 score on the training set of 13 of 14 analog circuits. The relationship between the F1 score and the decision threshold is plotted for one of the 14 executed runs of the RGCN model, as shown in FIG. 1.5. The optimal threshold of

5.26 is identified during the training phase, which corresponds to the peak F1 score on the training set as shown in FIG. 1.5. Note that the peak F1 scores for the two testing scenarios, which represent the ideal thresholds during testing, closely align with the curve of the peak F1 score for the training set, which represents the selected threshold. As indicated by the results shown in FIG. 1.5, at almost any threshold, the hybrid approach of applying the RGCN model to filter pairs determined by the VF2 algorithm results in a higher F1 score than applying the RGCN model alone (testing on all pairs).

Effort is needed to initialize and prepare for the execution of the hybrid approach, including building the library of primitives for matching and preparing the dataset for training. However, once initialization is complete, the execution time for both methods is generally fast. The VF2 algorithm results in a worst-case time complexity of O(n!n). The average execution time of the VF2 algorithm and the RGCN model is 0.589 seconds and 5.32 ms, respectively, as listed in Table 1.1. When applying the hybrid approach to determine and label transistor pairs of an unseen analog circuit, the average execution time is 0.594 seconds. Another limitation of the isomorphism-based approach is the requirement of explicitly enumerating analog primitives. Unlabeled circuit structures are not detected by the VF2 algorithm and, therefore, neither by the hybrid approach. However, at the device level, there is typically a small set of analog primitives that need to be identified.

The auto-determination of functional pairs demonstrates the capability of the RGCN model to learn from human-annotated labels from multiple circuits simultaneously. From a broader perspective of using machine learning in analog EDA, this work highlights that learning models do not necessarily have to be applied alone when addressing design problems. A hybrid approach that integrates learning models with heuristic algorithms potentially yields further improved performance, as the advantages of both types of algorithms are leveraged.

### Conclusions

In this Section I, a hybrid approach is presented that combines the subgraph isomorphism algorithm VF2 and an RGCN model to detect and classify analog functional pairs at the device level. The VF2 algorithm achieves a perfect recall of 1, recognizing all 120 functional pairs, but returns an average of 35.9% false positives. With the hybrid approach, which uses both VF2 and an RGCN model, an F1 score of 0.882 is achieved: a 14.4% improvement over applying VF2 alone. In addition, the edge type of each detected pair is returned. The average execution time for the hybrid approach is 0.594 seconds. The results demonstrate the effectiveness of the proposed hybrid approach for detecting analog functional pairs in practical applications for the modeling and design of analog circuits.

### II. Description for Background for Comparative Analysis of Graph Isomorphism and Graph Neural Networks for Analog Hierarchy Labeling

### Methodology and Problem Formulation

The primary objective of recognizing the primitives of an analog circuit at the device level is given as: Identify the set S containing all pairs of devices that belong to the functional pair type i, denoted as Si={(di1, di2), (di3, di4), . . . }, where din represents the nth device of the circuit. In Section II-A, VF2, the heuristic subgraph isomorphism algorithm used as the baseline for comparison with the proposed GNN models, is briefly introduced. The required graph representation and the library of target analog primitives are also described in Section II-A. In Section II-B, the proposed GNN model that detects and labels the type of analog functional pairing between devices is described.

### A. VF2: Subgraph Isomorphism for the Recognition of Analog Primitives

A subgraph isomorphism test is applied to determine whether the given graph G0 representing the circuit under test contains a subgraph that is isomorphic to the graph Gi of the ith analog primitive in a predefined library. In this work, the exact subgraph isomorphism algorithm VF2 is used as the baseline for comparison.

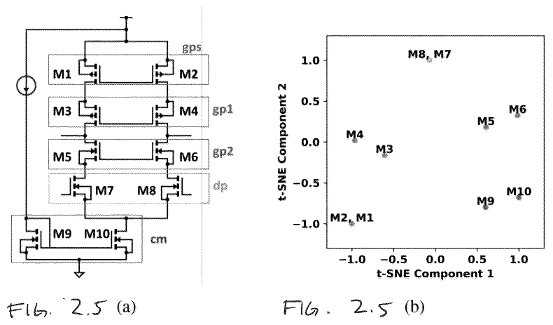

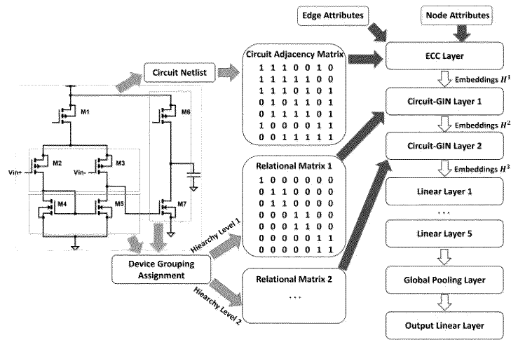

VF2 uses a state space representation and employs a depth-first strategy to search for an isomorphic match. The algorithm begins with an initial state s0, and candidate node pairs are generated and evaluated based on a set of feasibility rules. If the feasibility check is successful, indicating that the candidate pair represents an isomorphic subgraph, the pair is added to the next state si. The procedure recursively executes to explore all possible combinations of node pairs. The pseudocode for the VF2 routine is provided as Algorithm 1 (FIG. 2.2.1).

The primitive library used in this work is composed of seven functional topological structures that include a current mirror (cm), a level shifter (ls), cross-coupled pairs with (ccs) and without (cc) a shared source net, gate pairs with (gps) and without (gp) a shared source net, and a differential pair (dp). The topologies of the primitive cells are shown in FIGS. 2.1(a)-(g).

In the graph representation of a circuit used for subgraph isomorphism matching, each transistor is represented by three terminal nodes denoting the drain, gate, and source. In addition, an identity node is included, which is centrally located and exclusively connected to the three terminal nodes. Connections between the terminal nodes indicate circuit nets. The graph representation of an amplifier that is applied as input to the VF2 algorithm is shown outside the boxed area of FIG. 2.2.

### B. Relational GraphSAGE Model for Multi-Class Link Prediction of Analog Functional Pairings

Link prediction is defined as the statistical estimation of the presence and the type of link between two nodes of a graph. Link prediction has been used to recommend movies and friend connections in social networks. Heuristic techniques such as preferential attachment, Jaccard measure, graph edit distance, and cosine similarity have been proposed to assess similarity scores between nodes and to, therefore, provide an assessment of the likelihood that a link between two nodes exists. In previous approaches, GNNs have been shown to closely approximate heuristic techniques by learning to predict links from the local subgraphs of nodes. The similarity between two nodes is determined by evaluating the embeddings of the two nodes.

In this disclosure, a device-level circuit is represented as a heterogeneous graph, where a single node type represents devices and nine netlist edge types model connectivity between devices. An additional eight edge types model functional pairings, with seven denoting the functional relationship between pairings and one denoting no relation at all. Specifically, the nine netlist edge types represent all potential unidirectional connections between the terminals of two transistors. Each functional pairing edge type represents an analog primitive category, and one additional edge type is added that indicates the absence of any relation. As seven target primitives are defined in this work, eight functional pairing edge types are used.

As the eight pairing relations are mutually exclusive, the task of detecting analog functional pairs at the device level is transformed into a multi-class link prediction problem, wherein the type of link (edge class) is predicted. As an example, the results from the execution of the developed GNN model on the graph representation of an amplifier are shown in FIG. 2.2, with the 17 edge types marked in distinct colors.

The graph nodes include two categorical features that indicate the transistor type (N-type and P-type). In addition, to differentiate between the self terminal connections of a transistor and the self-loop typically required by GNN aggregation, a categorical feature is used to indicate the presence of a diode connection between the gate and the drain of a transistor. Supplementary features are included, when detection of such connections is required, to represent the less common drain source connection (transistor functioning as a capacitor) and gate-source connection.

The final model architecture incorporates relational GraphSAGE (R-SAGE) layers, which are formed by combining the principles of both the relational graph convolutional network (RGCN) and GraphSAGE (SAGE). For GraphSAGE, the mean of the embeddings obtained from the neighborhood of a given node is concatenated with the embedding of the node. The updated embedding hi of node i using GraphSAGE is expressed as shown in Equation 2.1 (FIG. 2.2.1), where o is the nonlinear activation function, W is the weight matrix, Ni is the set of neighboring nodes of node i, and ni is the size of Ni.

In an R-SAGE layer, the GraphSAGE methodology is applied iteratively on a given node to generate embeddings for each incident edge type. The final embedding of the node is then updated by summing the embeddings obtained from all nine edge types. The aggregation process ensures that information from different edge types is effectively integrated into the final embedding of the node within the heterogeneous graph, as given by Equation 2.2 (FIG. 2.2.1), where R is the set of nine netlist edge types, Wr is the weight matrix for the incident edge type r, Nr is the set of neighboring nodes connecting the destination node with edge type r, and nr is the size of Nr.

The embeddings of a pair of nodes, which are outputs from the last R-SAGE layer, are concatenated and passed through linear layers. The final linear layer generates a logit score vector with eight dimensions. Each dimension of the logit score indicates the likelihood of a pair belonging to a specific pairing edge class.

Cross-entropy loss is used as the loss function during training, which quantifies the difference between the predicted logit scores and the true functional classes. A log-softmax function is initially applied, which converts the logit scores into log-probability scores. The cross-entropy loss is given by Equation 2.3 (FIG. 2.2.1), where xk is the logit score for the target class k and d is the number of target classes. The mean of the cross-entropy loss of all logit scores is used as the final loss of the training set. The cross-entropy loss guides the optimization of model parameters, which ensures an effective mapping from the input pair representations to the correct functional class labels.

During testing, all potential edges between pairs of transistors in the test circuit are queried. Similar to the training set of circuits, the embeddings of a queried pair of transistor nodes are updated using the R-SAGE layers. The updated embeddings are then concatenated and passed through the linear layers, which generate a score for each pairing edge class. The model then identifies the class with the highest score as the predicted class for the queried edge. The model, therefore, assigns the functional pairing class with the highest probability score to the edge between a given pair of transistors.

Following the classification of edges using the R-SAGE model, a post-processing step is executed to identify functional groups comprised of more than two devices. When a transistor is detected in separate pairs of the same category, all devices comprising the separate pairs are merged into a single larger group. The merging of pairs frequently arises when multiple branches of a current mirror are present in a circuit.

Recall (true positive rate), precision (positive predictive value), F1 score, and accuracy are used to assess the prediction results, which are defined as, respectively shown in Equations 2.4-2.7 (FIG. 2.2.2), where TP, TN, FP, and FN represent the number of true positives, true negatives, false positives, and false negatives, respectively. In addition, the macro-averaged recall, precision, and F1 score for the multi-class classification are calculated as shown in Equation 8 (FIG. 2.2.2), where Metrici represents the recall, precision, and F1 score for the ith class, and k is the number of target classes (eight in this work).

### Simulation Results

The dataset used to evaluate the R-SAGE model includes 14 analog circuits that are comprised of a total of 219 transistors. For each circuit in the dataset, the functional groupings are manually labeled, which results in a total of 120 functional pairs that belong to the seven primitive categories described in Section II-A. Note that, unlike digital circuits, the device count of an analog circuit is often limited. For a hierarchical system level design, the proposed technique applies to discrete circuit blocks of the hierarchy, each of which is typically defined by a separate netlist. A heterogeneous graph is generated for each circuit, where netlist edges are generated based on the SPICE representation of the circuits and functional pairing edges are generated based on the annotated labels.

To address the imbalance of data during training, down sampling of the ‘no relation’ class is performed by including only 720 negative edges from all possible negative edges, which equals six times the total number of functional pairs (positive edges) of 120 present in the circuits. The model architecture includes two R-SAGE layers and two linear layers with hidden dimensions of 32 each. As the embeddings of a pair of nodes are concatenated and passed into linear layers for every edge type, the dimension of the inputs to the first linear layer is 64. The dimension of the output of the last linear layer is 8, which equals the number of pairing relations.

R-SAGE and VF2 are executed and compared for recognizing the functional pairings of an analog circuit. The deterministic VF2 algorithm is executed once to generate results. A cross-validation process is used to evaluate the performance of the R-SAGE models, which is executed 10 times for each model. In each round of cross-validation, one circuit is selected as the testing set, while the remaining 13 circuits are used as the training set.

The average performance and execution time of R-SAGE across the 10 executions of cross-validations are listed in Table 2.I (FIG. 2.1.1). The performance and execution time of VF2 are also listed in Table 2.I for comparison. The circuits comprising the dataset are listed in Table 2.2 (FIG. 2.1.2), where the performance of R-SAGE from one of the 10 executed runs is also provided. The results from the execution of the VF2 algorithm are summarized in a confusion matrix, as shown in FIG. 2.3(a). In addition, a confusion matrix of the predicted results of a single executed run of cross validation is shown in FIG. 2.3(b).

As a separate characterization, another R-SAGE model is trained on a dataset that excludes ‘no relation’ class data during training or testing. The presence of all functional pairings is assumed known, while the specific class of each pair is unknown. The objective of the model is to label the specific functional type for each queried pair. A confusion matrix that summarizes the prediction results is provided in FIG. 2.4.

### Analysis of Results

The diagonal values of a confusion matrix represent the number of true positives. As indicated by the confusion matrix shown in FIG. 2.4, the R-SAGE model achieves 100% labeling of the functional pairs when nodes with existing relations are queried. When all possible edges are queried, as indicated by the confusion matrix shown in FIG. 2.3(b), a reduction in the overall performance of the R-SAGE model is observed, which is attributed to the imbalance of the data due to the inclusion of a large number of ‘no relation’ edges.

Identifying a larger number of the existing functional pairs of a circuit, which results in a higher recall rate, is, therefore, a more important objective for the determination of functional groupings. As a comparison, precision is calculated based on the number of non-relational pairs that are labeled as functional pairs (false positives). Post-processing filtering is used to reduce the number of false positive functional pairs [10].

Upon analyzing the VF2 results, three primary factors contribute to the occurrence of false positives in the detected pairs. The most significant factor is associated with transistors whose source or drain terminals are connected to high-degree net nodes such as power or ground. Due to the connection, the transistors are erroneously recognized as differential pairs. The second factor that results in greater false positives is when pairs of transistors share a common clock signal or gate bias voltage, even when the transistors do not form a functional pair. The third factor involves instances where NMOS-PMOS pairs are incorrectly classified as cross-coupled pairs. As compared to the results produced by VF2, which are shown in FIG. 2.3(a), the R-SAGE model results in a reduced number of false positives (63 from 100) at a cost of missing 10 true pairs. In addition, as indicated by the results listed in Table I, the R-SAGE model provides a higher macro F1score of 0.864 and a faster average testing time of 80.3 ms as compared to VF2.

Unlike VF2, GNNs do not require a library of primitives. However, the learning-based approaches do require labels of the training set for each functional pairing class. The VF2 algorithm results in a worst-case time complexity of O(n!n). With GNNs, the total number of edges queried is calculated as n(n−1)/2 when testing on a circuit graph with n nodes. Therefore, without accounting for differences in model architectures, the time complexity of applying a GNN model is O(n2), which is more efficient than the factorial time complexity of the VF2 algorithm.

As compared to prior work, the R-SAGE model returns the type of each detected pair. Nodes from different categories of functional pairs exhibit different neighboring subgraph structures, which results in variation in the node embeddings. Instead of grouping all edges of functional pairs into one single positive class, defining distinct classes of functional pairs improves the expressiveness and utility of the model.

During testing, the transistor node embeddings of a telescopic OTA generated by the R-SAGE model, with a dimensionality of 32, are processed with t-distributed stochastic neighbor embeddings (t-SNE). The t-SNE technique performs nonlinear dimensionality reduction, reducing the embeddings to 2 dimensions. As a result, similar nodes are placed near one another, which allows for the visualization of the patterns found within the embeddings. An analysis of the processed embeddings of the transistors of a telescopic OTA is provided through results shown in FIGS. 2.5(a) and 2.5(b).

As shown in FIG. 2.5(b), for each of the five pairs of devices belonging to four functional pair categories, the two nodes comprising each pair are positioned close to each other while nodes from unlinked pairs are further apart. In particular, the embeddings of M7 and M8, as well as those of M1 and M2, are identical. The t-SNE plot validates the expressive power of the R-SAGE layers in generating distinguishable embeddings of neighboring subgraphs around a given node, which effectively contributes to the accurate determination of the type of functional pairing.

### Conclusions

In this Section, an R-SAGE GNN is developed and compared with the subgraph isomorphism algorithm VF2 for recognizing and labeling analog primitives at the device level. While VF2 determines device groupings, the R-SAGE GNN provides an improved average macro F1-score of 0.864 and an average testing time of 80.3 ms without requiring a predefined library of primitives. As compared to prior learning-based work, the model returns the functional pair type of determined groupings and does not require technology-dependent parameters. The proposed technique also provides an initial step towards machine recognition and analysis of circuits at the transistor level.

### III. Description for Circuit-GNN: A Graph Neural Network for Transistor-Level Modeling of Analog Circuit Hierarchies

Implementation Notes. The disclosed models may execute on general-purpose CPUs, GPUs, or AI accelerators. In some embodiments, ECC and Circuit-GIN operations are offloaded to a hardware accelerator that applies the same aggregation equations in a parallel compute fabric. In further embodiments, model training is distributed across multiple nodes with synchronous or asynchronous parameter updates. Predicted performance metrics are exported via a machine-readable interface (e.g., JSON or protobuf) for consumption by electronic design automation (EDA) tools.

### Methodology

A homogeneous graph representation of transistor-level analog circuits is proposed.

A. Graph Representation of Circuits at the Transistor Level and Learning with Edge-Conditioned Convolution

Denote the circuit feature space X and performance label space Y, where X∈Rd and Y∈Rk. For circuit sizing, the feature space primarily refers to the set of transistor dimensions (lengths and widths) to be determined. When considering supervised learning, a dataset is sampled from an independent and identically distributed feature space. A model is trained to learn a mapping function hk such that X maps to Yk (hk:X→Yk) for the kth circuit performance metric.

In applying GNNs, a graph G(V, E) is generated from the transistor-level netlist of a circuit, where V is the set of nodes that represent circuit devices and E is the set of edges that indicate connections between devices. An m-by-m adjacency matrix A is generated that encodes the graph structure, where m is the number of nodes in the graph (number of devices in the circuit). Aij is 1 if there is an edge between node i and node j, and 0 otherwise. Features are associated with graph nodes (devices), which results in a feature matrix F∈Rm×n corresponding to a circuit graph, where n is the dimensionality of the features of a node.

A complete GNN model architecture includes a sequential connection of GNN layers and post-processing layers. The GNN layers, based on the adjacency matrix, update the feature representation of each node by aggregating with features of the neighboring nodes either in the spectral or spatial domain. Stacking t GNN layers results in node representations constructed in the t-hop neighborhood of each node. The number of layers t is usually limited to 3 to prevent over smoothing of features, where the final node embeddings become indistinguishable. Following the GNN layers, task-specific linear layers are added to generate predictions for regression or classification tasks. For the performance modeling of analog ICs, regression is performed at the graph level as the performance labels are associated with the entire circuit.

A hyper-graph is well suited to represent a transistor-level circuit, where an edge (circuit net) connects to any number of graph nodes (circuit devices). While GNNs on hypergraphs have not been fully developed, all important information listed in a circuit netlist must be encoded into the graph representation for the proper training of the GNNs. In some approaches, a heterogeneous graph representation has been proposed to predict interconnect parasitic impedance, where two node types are used to model the devices and nets. However, a proper configuration of the GNNs when using a homogeneous graph generally results in equivalent or improved performance over existing heterogeneous GNN representations used for various target applications. Heterogeneous node types associated with different features result in an increased dimensionality of feature embeddings. In this work, a homogeneous graph representation is proposed, where a single node type is defined to represent devices. Connections between devices are represented by edges.

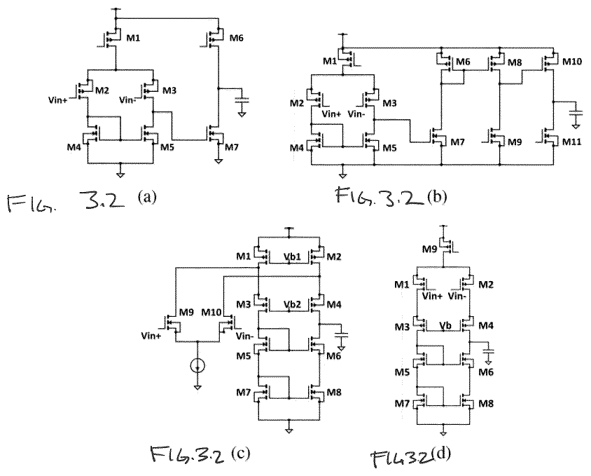

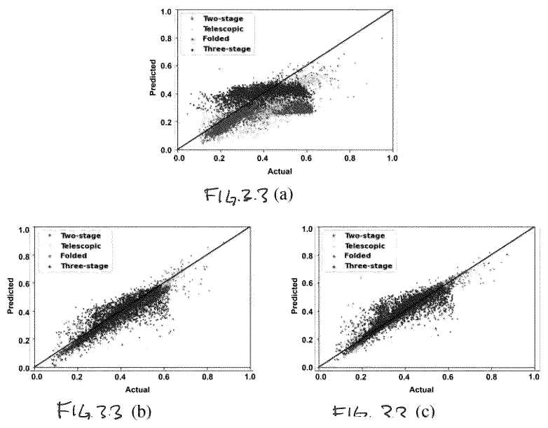

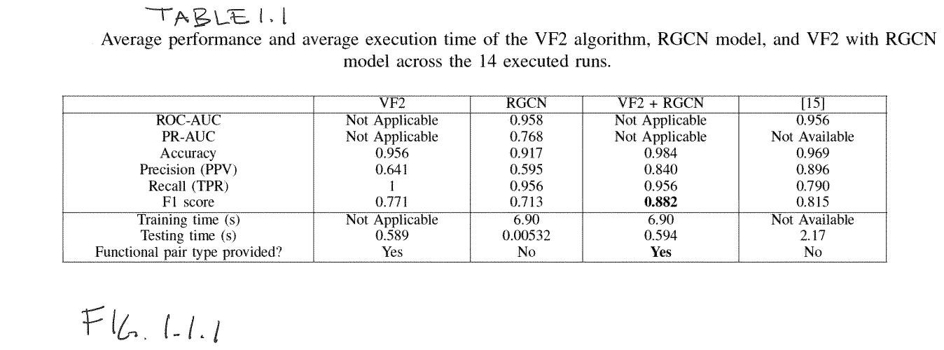

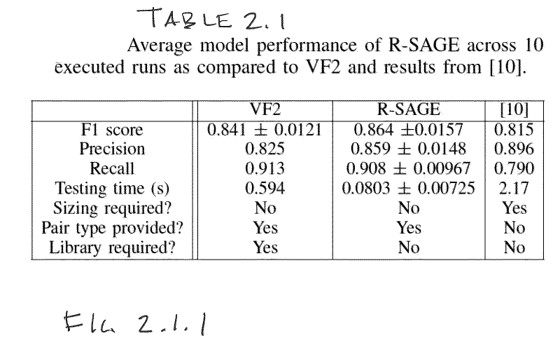

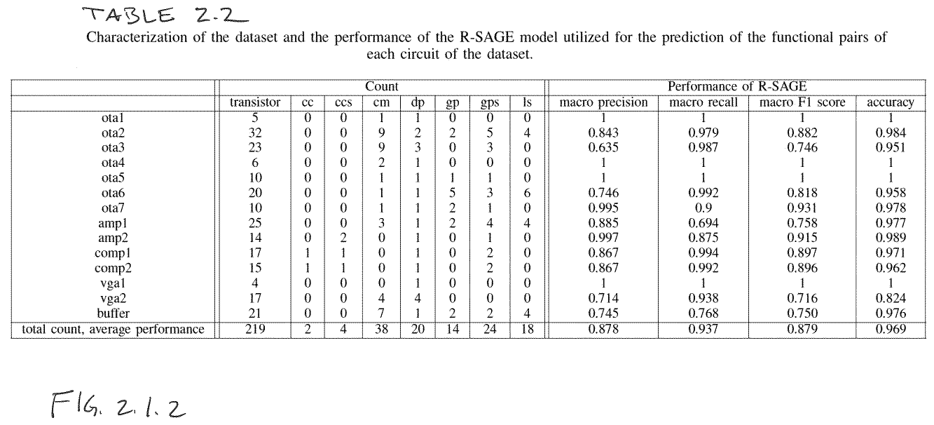

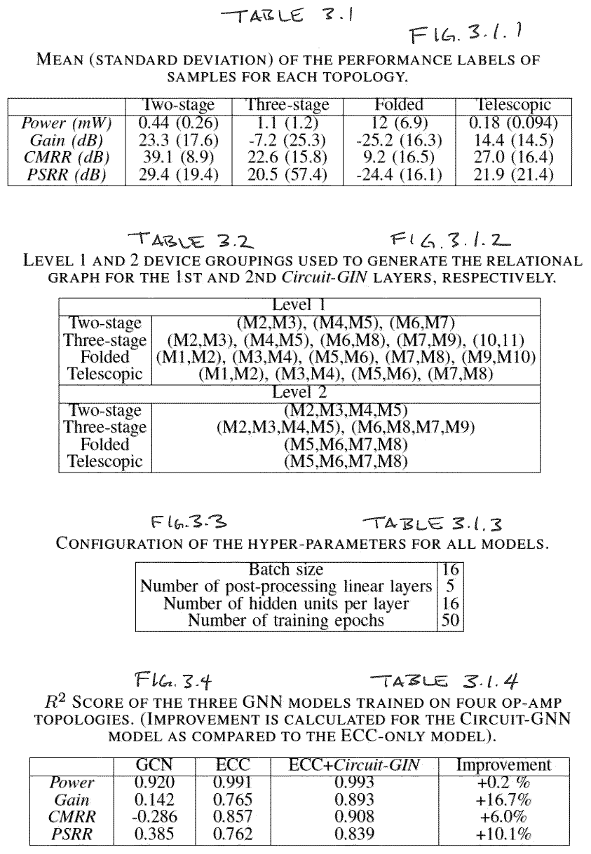

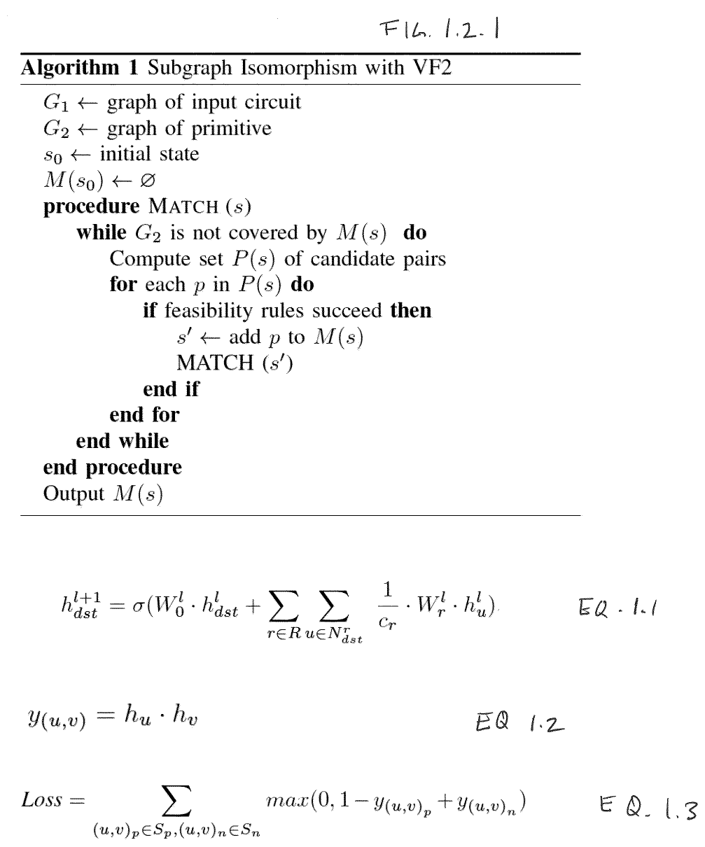

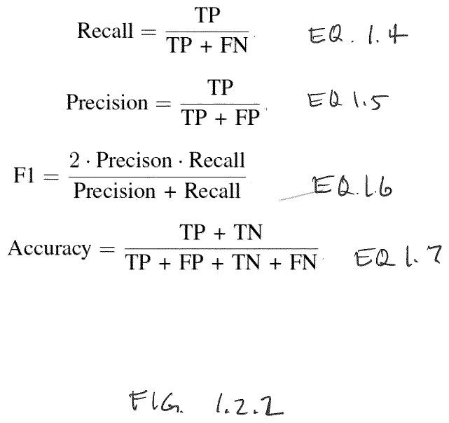

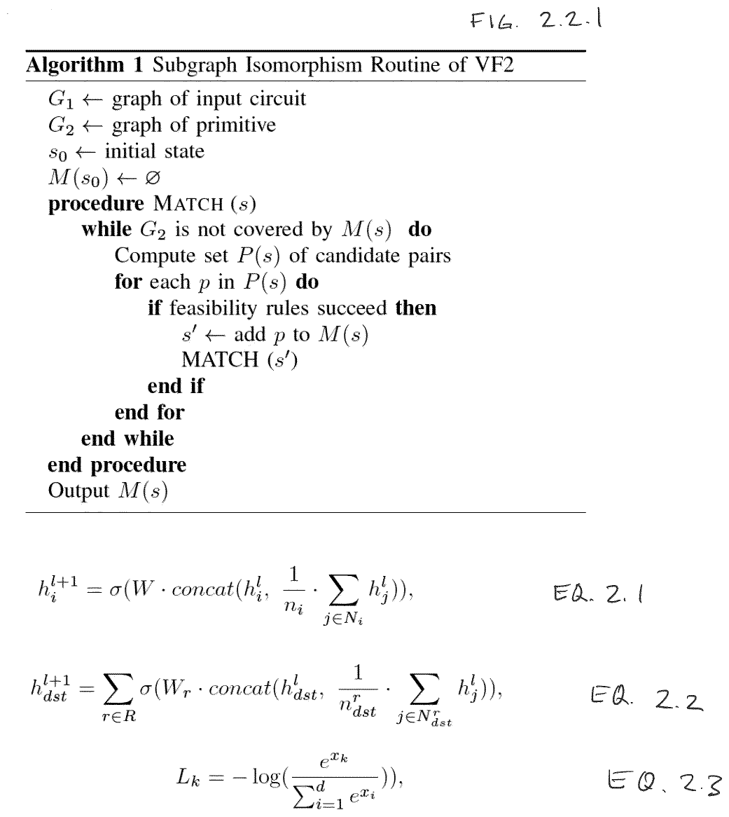

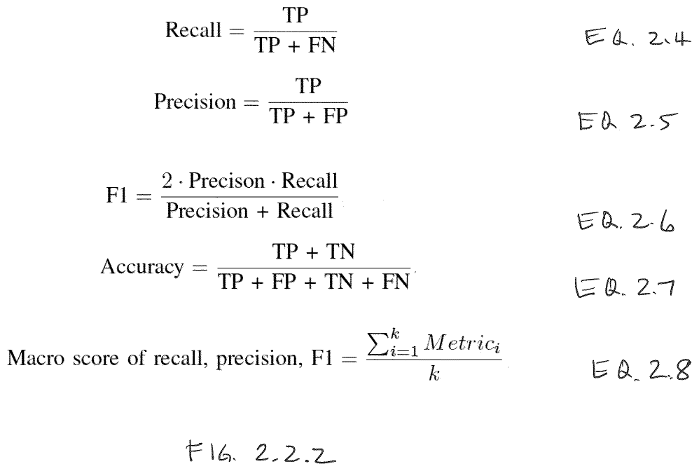

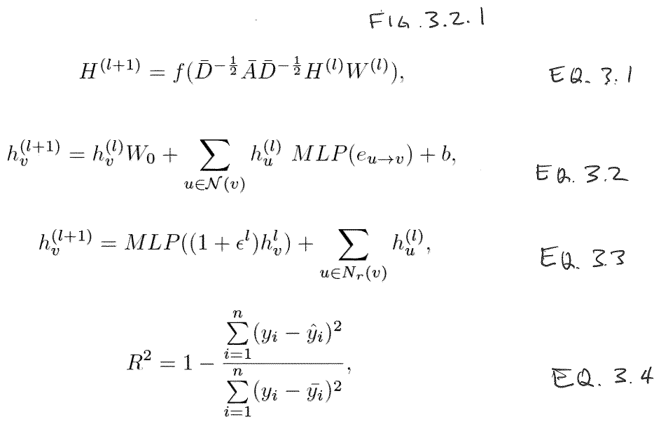

The vanilla graph convolution network (GCN) in the spectral domain is defined as shown in Equation 3.1 (FIG. 3.2.1), where H(l) is the node embedding at the lth layer, f is the activation function, D⁻ is the degree matrix of the graph, A is the addition of the adjacency matrix A with the identity matrix I, and W(l) is the trainable weight matrix. The identity matrix is added to the adjacency matrix to account for the intrinsic self-loop of each node of the graph, which guarantees that the embedding of the current node is accounted for when aggregating with neighboring nodes. When representing each transistor as a graph node, the self-loop and the self connection between the gate and drain (i.e., diode connected) result in an ambiguity in the model, where even if no self-connections of the terminals of a node are present, a self-loop is still required by the GCN model. As the behavior of a transistor changes significantly with self-connected terminals, in this work, an additional categorical feature is added to the node feature list that explicitly represents the presence of a self connection on a transistor node. Specifically, a categorical feature is included for a diode-based self connection that is often present in amplifier topologies. Similarly, a drain-source connection (i.e., a transistor used as a capacitor) and a gate source connection, although uncommon, on the same transistor are also represented with additional features if required.

To leverage edge information during learning, a one-hot encoding of six types of edges is used to represent the six possible connections between a pair of transistors: drain-drain, gate-gate, source-source, drain-gate, drain-source, gate-source. Dynamic edge-conditioned convolution (ECC) [18] is adopted as the aggregation method. With ECC, weight matrices conditioned on the edge attributes are trained in a local neighborhood of a node. In the spatial domain, the operation of ECC is given by Equation 3.2 (FIG. 3.2.1), where hl is the embedding of node v at the lth layer, W0 is the weight matrix of node v, N (v) is the set of neighboring nodes of node v, b is the bias term, and MLP (eu→v) is a multi-layer perceptron for a specific edge type.

### B. Circuit-GIN: Aggregation Based on Device Groupings

Groupings of devices in an analog circuit, when considering matching and symmetry, provide additional design information. In particular, constraints on symmetry are typically applied to differential pairs, while matching is applied to current mirrors. The groupings of devices in an analog circuit are determined with four primary approaches based on the identification of functional analog building blocks. The first approach is to determine the device groupings by expert labeling. The second approach is to train supervised learning models on expert-labeled data to identify the device groupings. The third approach is to formulate a look-up table of viable building blocks and apply a graph isomorphism test to search for matches with subgraphs of a given circuit. The fourth approach is to use graph clustering algorithms such as Kmeans and spectral clustering to identify and group devices automatically. Typically, a metric is defined to evaluate the similarity between nodes such that nodes with commonality are grouped together. However, with the fourth approach, only one level of hierarchy is provided, and the resulting groups typically deviate from the groups determined by expert designers. As device groupings require a smaller human effort as compared to quantitative analysis, the grouping of devices is assumed to be provided by the designer in this work.

Different criteria have been proposed to partition an analog circuit hierarchically. In this work, two levels of hierarchy are used to group devices. At level 1, a building block is formed by two transistors. Examples include a differential pair, a cross-coupled pair, a cascode pair, and a current mirror. At level 2, analog building blocks includes four transistors are considered. Examples include a cascode current mirror and a Wilson current mirror. If a system-level circuit such as a PLL is considered, a third level of hierarchy (level 3) is added that represents the grouping of devices in sub-circuits.

With traditional GNN operations, node embeddings are aggregated based on the circuit graph. To account for device grouping information, a relational graph is generated for each level of the circuit hierarchy. Specifically, an edge is added between a pair of transistors in the relational graph if the transistors belong to the same group in the hierarchy. As a result, a relational matrix T is generated with the same dimension as the adjacency matrix (m-by-m) for a graph with m nodes.

If two input graphs are non-isomorphic, an expressive GNN generates distinguishable embeddings for each graph, which is achieved by using graph isomorphism networks (GIN) that are based on sum-pooling. The weight of a given node is updated with a learnable parameter e that indicates the importance of the center node relative to the neighboring nodes of a GIN layer. Using GIN as the base aggregation operation, the Circuit-GIN layer that processes the relational graph is defined as shown in Equation 3.3 (FIG. 3.2.1), where Nr(v) is the set of neighboring nodes of node v in the relational graph. The Circuit-GIN layers further aggregate node embeddings based on relations between transistor nodes after completing aggregation based on the graph topology. The number of Circuit-GIN layers is equivalent to the number of levels of hierarchy representing a given circuit. Therefore, hyperparameter tuning is not required to determine the optimal number of Circuit-GIN layers. An illustration of the model architecture formed with an ECC layer and two Circuit-GIN layers is shown in FIG. 3.1.

Hierarchy-Aware Variants. Circuit-GIN layers are exemplary. Any hierarchy-aware GNN layer that aggregates node embeddings using relational adjacency derived from designer-provided device groupings (e.g., message-passing networks with group-wise pooling or attention over group relations) may be substituted without departing from the scope of the invention.

### Simulation Results

The proposed techniques are implemented and executed on a mixed dataset of four op-amp topologies designed in a 65 nm technology. A schematic representation of each of the four opamps (two-stage, three-stage, folded cascode, and telescopic cascode) is shown in FIGS. 3.2(a)-3.2(d) respectively. For each op-amp topology, Latin Hypercube Sampling is applied to generate 10000 sets of transistor widths that are constrained between 0.13 μm and 300 μm. The transistor lengths are set to twice the minimum length allowed to mitigate the effect of channel length modulation and process variation. The load capacitance CL is set to 250 fF. Four performance metrics, gain, power, common mode rejection ratio (CMRR), and power supply rejection ratio (PSRR), are evaluated with SPICE simulation in Cadence Virtuoso for each set of widths.

The mean and standard deviation of the performance labels of the sampled dataset for each op-amp circuit is listed in Table 3.I (FIG. 3.1.1). 75% of the final dataset of 40000 points is selected for training and the remaining 25% is used for testing. The feature list of device nodes includes the transistor size, transistor type (N/P), and a categorical feature that indicates the presence of a drain-gate connection (diode). The other two types of self-connections are not present in the four explored amplifier topologies. The final Circuit-GNN model architecture includes a sequential connection of one ECC layer, two Circuit-GIN layers, and five post-processing linear layers as shown in FIG. 3.1. The level 1 and level 2 groupings of devices used to construct the relational graph provided to Circuit-GIN layer 1 and 2, respectively, are listed in Table 3.2 (FIG. 3.1.2). Two baseline models are implemented for comparison. The first baseline model is composed of one vanilla GCN layer and five linear layers. The second baseline model includes one ECC layer and five linear layers. Except for the difference in GNN layers, the configuration of all the hyperparameters related to the model architecture and training are kept the same, as summarized in Table 3.3 (FIG. 3.1.3). The R2 score is used to evaluate the prediction models, defined in Equation 3.4 (FIG. 3.2.1), where y denotes the actual values, y\hat{ } the predicted values, and y⁻ the mean of the actual values. The results from characterizing the performance of the three models on the test set are listed in Table 3.4 (FIG. 3.1.4). The predicted and actual CMRR is shown in FIG. 3.3(a)-3.3(b) for the three models.

Training & Transfer. The Circuit-GNN may be pretrained on datasets from a first set of topologies and fine-tuned on a second set of topologies and/or technology nodes. To improve generalization across technologies, the graph excludes technology-dependent sizing parameters unless explicitly stated in an ablation setting.

### Discussion

From the results listed in Table 3.4, all three models output accurate predictions for power, as the power consumption of a circuit follows a linear relationship and is, therefore, less challenging to predict. For the prediction of gain, CMRR, and PSRR, the model with one GCN layer results in poor R2 scores, and is significantly outperformed by the model with one ECC layer. The results indicate that only ECC-based models distinguish between the four topologies by generating distinct embeddings used for prediction. The device node features of sizing, type, and indicator of diode connection, and the six edge types that account for transistor-to-transistor terminal connections all contribute to the generation of distinct node embeddings for each transistor of each circuit learned by the ECC layer. The embeddings are then pooled to generate the target performance predictions. From the means and standard deviations listed in Table 3.1, the four circuits differ in the distributions of the performance labels for all of the four performance metrics. If the embeddings generated for different circuits are indistinguishable, the model fails to accurately predict the target performance parameters based on the given set of embeddings.

In addition, from the R2 scores listed in Table 3.4, the ECC-based model with the additional Circuit-GIN layers outperforms the model includes only one ECC layer in the prediction of all four performance parameters. Specifically with the highest improvement of 16.7% in R2 score, the gain predictor benefits the most from the device grouping information encoded in the relational graphs learned by the Circuit-GIN layers.

The performance of the three models is also compared by analyzing the predicted and actual values of the CMRR as shown in FIG. 3.3(a)-(c). The predictions for CMRR generated by the GCN-based model spread and deviate from the ideal linear line. The CMRR is underestimated for the two-stage and folded-cascode op-amps. With the ECC-based model, the errors, shown as deviations from the ideal line, are smaller. However, the ECC-based model without the Circuit-GIN layers still underestimates the CMRR of the two-stage op-amp, as shown by the red points in FIG. 3.3(b). As a comparison, the model includes both the ECC and Circuit-GIN layers provides predictions that more closely align with the ideal line (true data).

With vanilla GCNs, the similarity between nodes is measured primarily by the closeness of the nodes in the graph topology. Therefore, node clustering is implicitly performed with a GCN model. However, with vanilla GCNs, the automatically generated groupings of devices do not always match the ideal groupings of devices based on circuit knowledge. The resulting aggregation is, therefore, not performed based on circuit knowledge. As an example, in deriving the gain expression for an amplifier with small-signal analysis, the gain of the entire circuit is the multiplication of the gain of each individual stage. Intuitively, performing intra-stage aggregation of embeddings is preferred before inter-stage aggregation of embeddings. With the proposed Circuit-GIN layers, such design knowledge is used to determine the aggregation.

### Conclusions

A graph representation is proposed to model analog circuits at the transistor level. ECC is used to learn the graph structures and node features conditioned on the edge types. Circuit-GIN is proposed to aggregate node embeddings based on a relational graph that encodes the device grouping information specified by a designer. The model includes an ECC layer and two Circuit-GIN layers is trained on a mixed dataset of four op-amp topologies. Results indicate that the ECC-based models outperform the GCN-based model in predicting all performance parameters. The inclusion of Circuit-GIN layers in the ECC-based model, i.e., CircuitGNN, results in an additional improvement of up to 16.7% in R2 score. Therefore, aggregation of node embeddings based on device groupings brings additional benefit to guide the GNNs for the performance modeling of analog ICs. The work is also proof of the expressive power of the GNNs to generate embeddings that distinguish between different circuit graphs. The generalization provided by GNNs renders feasible the simultaneous learning from different analog topologies.

Additional Note: Class Balancing and Visualization. “No-relation” edges may be down-sampled to address class imbalance during training. Learned embeddings may be visualized with dimensionality-reduction techniques (e.g., t-SNE or UMAP) to validate separability across functional classes.

While the invention has been described with reference to the embodiments above, a person of ordinary skill in the art would understand that various changes or modifications may be made thereto without departing from the scope of the claims.

We claim:

1. A computer-implemented method for detecting and classifying functional device pairs in an analog circuit, comprising:
(a) receiving a circuit netlist representing the analog circuit;
(b) generating, from the circuit netlist, a graph representation comprising: (i) nodes representing transistors; and (ii) edges representing electrical connections between transistor terminals;
(c) executing a subgraph isomorphism algorithm on the graph representation to identify candidate functional device pairs;
(d) processing the candidate functional device pairs with a trained relational graph convolutional network (RGCN) model to generate link prediction scores for functional connectivity; and
(e) returning, for each validated functional device pair, a category label identifying a functional type of the pair.

2. The method of claim 1, wherein the subgraph isomorphism algorithm comprises a VF2 algorithm.

3. The method of claim 1, wherein the functional type is selected from the group consisting of: current mirror, level shifter, cross-coupled pair with shared source, cross-coupled pair without shared source, gate pair with shared source, gate pair without shared source, and differential pair.

4. The method of claim 1, wherein the graph representation comprises ten edge types including nine netlist edge types and one functional pairing edge type.

5. The method of claim 1, wherein the RGCN model computes link prediction scores using a dot product between node embeddings of transistor pairs.

6. The method of claim 1, further comprising filtering false positives from the candidate functional device pairs by thresholding the link prediction scores.

7. The method of claim 6, wherein the threshold is selected to maximize an F1 score on a validation dataset.

8. A computer-implemented method for labeling functional device pairs in a transistor-level analog circuit, comprising:
(a) generating, from a circuit netlist, a heterogeneous graph comprising: (i) nodes representing transistors; (ii) netlist edge types representing unidirectional terminal-to-terminal connections; and (iii) functional relation edge types representing functional pairings;
(b) applying a relational GraphSAGE (R-SAGE) model to predict, for each queried transistor pair, a functional pairing class; and
(c) outputting the predicted class for use in circuit design.

9. The method of claim 8, wherein the functional pairing class is selected from the group consisting of: current mirror, level shifter, cross-coupled pair with shared source, cross-coupled pair without shared source, gate pair with shared source, gate pair without shared source, differential pair, and no relation.

10. The method of claim 8, wherein node features exclude technology-dependent parameters including device sizing.

11. The method of claim 8, further comprising merging overlapping pairs of the same category into multi-device functional groups.

12. The method of claim 8, wherein the heterogeneous graph comprises at least nine netlist edge types and eight functional relation edge types.

13. The method of claim 8, wherein the model is trained using cross-entropy loss and a down-sampled set of “no relation” edges.

14. The method of claim 8, wherein the method achieves a macro F1-score exceeding that of a subgraph isomorphism algorithm applied to the same circuits.

15. A computer-implemented method for predicting performance of an analog circuit, comprising:
(a) generating, from a transistor-level netlist, a homogeneous graph with nodes representing devices and edges representing electrical connections;
(b) associating each node with categorical features indicating transistor type and one or more self-terminal connection types;
(c) applying an edge-conditioned convolution (ECC) layer to update node embeddings based on edge attributes;
(d) applying a plurality of hierarchy-aware graph neural network layers to aggregate node embeddings based on device groupings; and
(e) generating one or more predicted performance metrics from the aggregated node embeddings.

16. The method of claim 15, wherein the hierarchy-aware graph neural network layers comprise Circuit graph isomorphism network (Circuit-GIN) layers.

17. The method of claim 15, wherein the edge attributes comprise drain-drain, gate-gate, source-source, drain-gate, drain-source, and gate-source connections.

18. The method of claim 15, wherein the hierarchical device groupings comprise at least a first level of paired transistors and a second level of four-transistor structures.

19. The method of claim 15, wherein the number of hierarchy-aware layers corresponds to the number of hierarchy levels and is applied without hyperparameter tuning.

20. The method of claim 15, wherein the performance metrics comprise at least gain, power, common-mode rejection ratio (CMRR), and power supply rejection ratio (PSRR).
